(19) United States
(12) Patent Application Publication
(10) Pub. No.: US 2016/0073646 A1
(43) Pub. Date: Mar. 17, 2016

(54) A Method of Animal Processing

(71) Applicant: NOLCHIRI INNOVATIONS LIMITED, Te Awamutu (NZ)

(72) Inventor: James Henry Riley, Hamilton (NZ)

(21) Appl. No.: 14/786,600

(22) PCT Filed: Apr. 24, 2014
(86) PCT No.: PCT/NZ2014/000073

§ 371 Date: Oct. 23, 2015

(30) Foreign Application Priority Data
May 6, 2013 (NZ) 610233

(51) Int. Cl. A22B 5/00; A23B 4/07; A23B 4/08; A22B 3/06; A22B 5/18

(52) U.S. Cl. CPC A22B 5/0076; A22B 3/06; A22B 5/0005; A22B 5/0017; A22B 5/0082; A22B 5/18; A23B 4/08; A23B 4/07; A23V 2002/00

(57) ABSTRACT

A method of processing a plurality of animal carcasses in an industrial processing plant comprising removing substantially all the blood from the two or more animal carcasses, then refrigerating or freezing the animal carcasses prior to hide removal and evisceration.

### TECHNICAL FIELD

This application relates to a new process for processing animal carcasses. In particular, the process relates to the preparation and cooling of whole animal carcasses to minimise bacterial contamination.

### BACKGROUND ART

Standard animal processing methods are used throughout the meat processing industry to prepare animal carcasses for both exporting and supplying to local markets.

One of the biggest problems in animal processing is the introduction of spoilage and pathogenic bacteria to the carcass during processing. Contamination of a carcass can occur through many practices, such as a general lack of hygiene and cleanliness in a processing plant, cross-contamination from the skin and organs of a carcass to the meat during skinning and/or evisceration and prolonged exposure to elevated temperatures which enhance microbial growth.

Any poor standards of hygiene during slaughtering or carcass handling can result in high levels of microbial contamination in the meat, reducing shelf-life of the product due to excessive contamination with spoilage bacteria and food safety hazards due to contamination with pathogenic bacteria. This can affect the acceptability of the product into foreign markets. Carcasses that are processed for export to some markets are subject to rigorous biological testing to be eligible for export to the country. There is therefore a need to develop a simple, cost effective method for processing animal carcasses that minimises microbial contamination as much as possible.

Currently, animal carcasses are processed using a standard method that involves stunning the animal to render it unconscious, cutting the throat to kill the animal and allow blood to drain from the animal, removal of the skin and removal of the internal organs. The organs are typically packed and refrigerated and carcasses placed in an air chiller to lower the carcass temperature to 7° C. or lower. Following chilling, carcasses are typically boned and packed.

There are a number of disadvantages with the currently used method. During the removal of the skin there is a huge potential for cross contamination of the meat. Animal skins contain very high numbers of bacteria, which may be transferred to the animal carcass during the skin removal. Additionally, skin removal is typically conducted near the beginning of the process, before refrigeration has occurred. This warm environment provides an excellent breeding ground for spoilage and pathogenic bacteria.

A further contamination risk occurs during evisceration and removal of the internal organs. Again, this is typically conducted at room temperature which provides optimal growing conditions for any bacteria present. Removal of the gastrointestinal tract also exposes the carcass to contamination risk if for example part of the intestine, stomach or bowel is perforated or leaks during removal.

Current practices typically require a worker to wash their hands and sterilise the knife a number of times during the processing of a single carcass, largely due to the unsanitary state of the hide. It would be useful to provide a method of animal processing that reduces the need for multiple occurrences of hand/knife washing and/or sanitation during processing.

It would be advantageous to provide an animal processing method that reduced meat contamination risk, as well as providing a simple, cost effective processing method. It is an object of the invention to provide such a method or at least provide processors and the public with a useful choice.

It is a further object of the invention to address the above problems, or at least provide processors and the public with a useful choice.

Further aspects and advantages of the present invention will become apparent from the ensuing description which is given by way of example only.

### DISCLOSURE OF THE INVENTION

According to a first embodiment of the invention there is provided a method of processing a plurality of animal carcasses in an industrial processing plant, the method comprising removing substantially all the blood from two or more animal carcasses, then refrigerating or freezing the animal carcasses prior to hide removal and evisceration.

According to a further embodiment of the invention there is provided a method of processing a plurality of animal carcasses in an industrial processing plant, the method comprising removing substantially all the blood from two or more animal carcasses, then refrigerating the carcasses prior to hide removal at temperatures of between 10° C. and −60° C.

In one embodiment of the invention, the carcasses are refrigerated using internal and/or external application of a salt brine solution of between 10° C. and −51° C.

In an alternative embodiment, the carcasses are refrigerated using air refrigeration at temperatures between 10° C. and −60° C.

Preferably, the animal hides remain substantially intact following blood removal.

In alternative embodiments, for example in halal animal processing, the animal hides remain substantially intact with the exception of a transverse incision across the neck.

According to a further embodiment of the present invention there is provided a method for processing a plurality of animal carcasses in an industrial processing plant, for each animal/animal carcass the method comprising the steps of:
a) stunning an animal;
b) removing blood from the animal carcass;
c) evacuating the stomach; and
d) refrigerating the animal carcass

wherein the hide remains substantially intact on the animal or animal carcass throughout steps a) to d).

According to a further embodiment of the present invention there is provided a method for processing a plurality of animal carcasses, for each animal carcass the method comprising the steps of:
a) removing blood from the animal carcass;
b) evacuating the stomach;
c) evacuating the colon;
d) flushing colon with disinfectant solution;
e) washing and sanitisation of carcass hide;
f) rinsing carcass;
g) refrigerating the animal carcass

wherein the hide remains substantially intact on the animal or animal carcass throughout steps a) to g).

In further embodiments, the method for processing animal carcasses further comprises one or more of the steps of;
a) stunning the animals prior to blood removal;
b) following refrigeration, removal of the animal hide;
c) following refrigeration, evisceration and/or offal removal; and
d) following refrigeration, boning of the carcasses.

In further preferred embodiments of the invention the blood is removed from the animal carcasses using a hypodermic needle or knife.

More preferably, the knife is a vampire knife.

Preferably, the vampire knife is adapted to connect to a sterilized collection means, allowing blood to flow directly from the animal into the sterilized collection means for future use.

In one embodiment, the blood is removed from the animal carcasses using a hypodermic needle inserted into the jugular vein. Even more preferably, the needle is a 10-14 gauge hypodermic needle operated using a syringe mechanism.

In alternative embodiments blood may be removed using a transverse cut across the throat. For example, this technique may be used in halal meat processing.

When the above alternative method of blood removal is employed, the method comprises the further step of trimming substantially all tissue that is exposed during blood removal, the trimming step occurring after hide removal and evisceration.

In preferred embodiments, when an open wound is left following blood removal, the wound is sealed prior to hide washing and refrigeration.

More preferably, the wound is sealed using a clip mechanism, sutures, staples, waterproof adhesive, skin sealant or other techniques known in the art. Preferably, the sealing means used prevents water or brine from entering the wound during washing and refrigeration.

In further preferred embodiments, the stomach and/or colon is evacuated and flushed clean using fluid introduced and removed through the oesophagus.

In preferred embodiments the fluid may be selected from water, CO₂, deoxygenated water, nitrogen or other inert gas.

In alternative embodiments, the stomach and/or colon is fully or partially evacuated using a suction mechanism.

In further optional method steps, the method includes the step of applying a vacuum to the stomach and/or colon cavity.

In further embodiments, the method includes the step of coating the stomach and/or colon cavity wall with an oxygen barrier.

Preferably, the oxygen barrier is a starch and/or methylcellulose barrier. However, as would be clear to a person skilled in the art any non-toxic, food grade substance that is capable of acting as an oxygen barrier may be used in this step of the method.

In further method steps, the carcass hides are washed using detergent and agitation methods.

In one preferred embodiment, the carcass hides are sanitized using ozone, chlorine or other disinfectants.

More preferably, the sanitization step occurs using immersion tanks, spray systems or other known hide washing techniques.

In further preferred embodiments, the carcasses are externally and/or internally refrigerated using a low temperature liquid solution.

Preferably, the refrigeration process comprises submerging or partially submerging carcass in a low temperature liquid bath or series of liquid baths; and/or by internal flushing with low temperature liquid.

Alternatively, the refrigeration process comprises applying a low temperature liquid spray or series of low temperature liquid sprays to the animal carcass.

Preferably the low temperature liquid is a salt brine solution.

In preferred embodiments of the invention the carcasses are refrigerated using a salt brine of between 7° C. and −51° C.

More preferably, the salt brine bath and/or salt brine spray is between −20° C. and −30° C.

In one embodiment, the carcasses are submerged in one or more brine baths or sprayed with the low temperature spray until the deep carcass temperature is reduced to between 7° C. and −15° C.

In a further preferred embodiment, the carcasses are is submerged in one or more brine baths or sprayed with the low temperature spray until the surface carcass temperature is substantially between 2° and 4° C.

In alternative preferred embodiments, the carcasses are submerged in one or more brine baths or sprayed with the low temperature spray until the deep carcass temperature is substantially between −1.0° C. and −1.7° C.

Preferably, carcasses for freezing are submerged in one or more brine baths or sprayed with the low temperature spray until the deep carcass temperature is substantially −12° C. and −20° C.

In preferred embodiments the salt brine bath is a NaCl and/or CaCl bath. More preferably, the salt brine bath has a salt concentration of 15% to 30%.

In alternative embodiments the salt brine is a saturated solution.

In further preferred embodiments the internal refrigeration of the carcasses comprises flushing the stomach through the oesophagus with a salt brine solution.

More preferably, the salt brine solution for internal refrigeration is between 0° C. and −51° C.

Even more preferably, internal refrigeration step continues until the internal carcass temperature is substantially −1.0° C. and −1.7° C. for refrigerated carcasses and −12° C. and −20° C. for frozen carcasses.

Preferably, following external refrigeration using low temperature fluid, the hide is dried in an air chiller at −1.7° C. with high air flow.

In alternative embodiments, the carcasses are refrigerated using air refrigeration and/or air freezing methods.

In preferred embodiments, the step of air refrigeration or air freezing is implemented until the deep carcass temperature is reduced to between 7° C. and −20° C.

Even more preferably, the air refrigeration step continues until the internal carcass temperature is substantially −1.0° C. and −1.7° C. for refrigerated carcasses and −12° C. and −20° C. for frozen carcasses.

According to a further aspect of the invention, there is provided an animal carcass processed using the method discussed in further detail above.

According to a still further aspect of the invention, there is provided a method of reducing bacterial contamination of an animal carcass, the method including processing the animal using the method discussed in further detail above.

Throughout the specification there are a number of terms that should be interpreted with the following meanings;

The term “industrial processing plant” should be taken to mean any processing plant that is used to process a number of animals for commercial purposes.

The term “vampire knife” should be given the standard meaning in the art of meat processing. A typical vampire knife is a knife adapted to insert directly into an animal's artery and is often connected to a tube, allowing blood to drain directly from the artery into a sterilised container or similar.

The term “deep carcass temperature” should be taken to mean the temperature of a carcass measured at the thermal center of the largest muscle mass. For example, in cattle the deep carcass temperature will be measured in the hind leg, which is the largest muscle mass.

The term “surface carcass temperature” should be taken to mean the temperature of an animal as measured at substantially 1 cm below the surface of the skin.

A “low temperature” liquid bath is intended to mean a bath with a temperature lower than ambient temperature. In preferred embodiments of the invention the liquid bath will be in the temperature range of 10° C. to −51° C.

The term “stomach” should be given its standard meaning, that being the area of the digestive system between the oesophagus and the small intestine. In the case of ruminants or other animals, the term “stomach” should be read as collectively describing one or more chambers present within the stomach cavity. For example in a ruminant, the term “stomach” includes the rumen, reticulum, omasum and abomasum.

The terms “refrigerate” or “refrigerating” should be taken to mean the basic process of removing heat from the animal carcass. It is intended to cover all the process across all temperature ranges including those below 0° C. which may commonly be referred to as “freezing”.

“Substantially intact” hide for the purposes of this specification should be taken to mean an animal hide that remains largely in its original state without significant cuts or openings. In the preferred method of the invention, blood is removed from the animal using a hypodermic needle or vampire knife. A small puncture wound in the animal hide or similar minor incision such as would occur in using these tools should be considered to be within the scope of leaving the hide substantially intact.

In circumstances where an animal is processed using halal processing methods, a larger incision may be necessary to release the animal's blood. It is envisaged in such circumstances the incisions are kept as small as possible in order to reduce bacterial contamination. When using the halal processing method the meat/product underlying the area where the skin is cut must be removed by trimming following skin removal and evisceration.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 shows a non-halal animal processing method in one preferred form of the invention using brine refrigeration; and

FIG. 2 shows a halal animal processing method in one preferred form of the invention.

FIG. 3 shows a non-halal animal processing method in an alternative form of the invention using air refrigeration.

### DESCRIPTION OF THE INVENTION

The present invention provides a new method for the processing of animals. The method has been devised as a new processing method that reduces microbial contamination of meat during processing compared to existing processing methods, as well as providing a more cost effective solution to the current known processes. The methods described are intended for use on a commercial scale to be applied and used in industrial meat processing facilitates. For ease of demonstrating the invention the description is discussed below in reference to a single animal or carcass, although in use may be applied to any number of carcasses.

In broad terms the process comprises the refrigeration of an animal carcass following blood removal using a minimally invasive process. The carcass hide remains intact on the animal, providing a barrier to external bacteria present on both the external surface of the hide and in the processing environment. Following refrigeration of the carcass, the carcass may be exported in a chilled or frozen state, where it is then skinned, eviscerated, inspected by government approved meat inspectors and boned at the destination. Alternatively, the carcass may be skinned, eviscerated, inspected by government approved meat inspectors and boned in the country of origin.

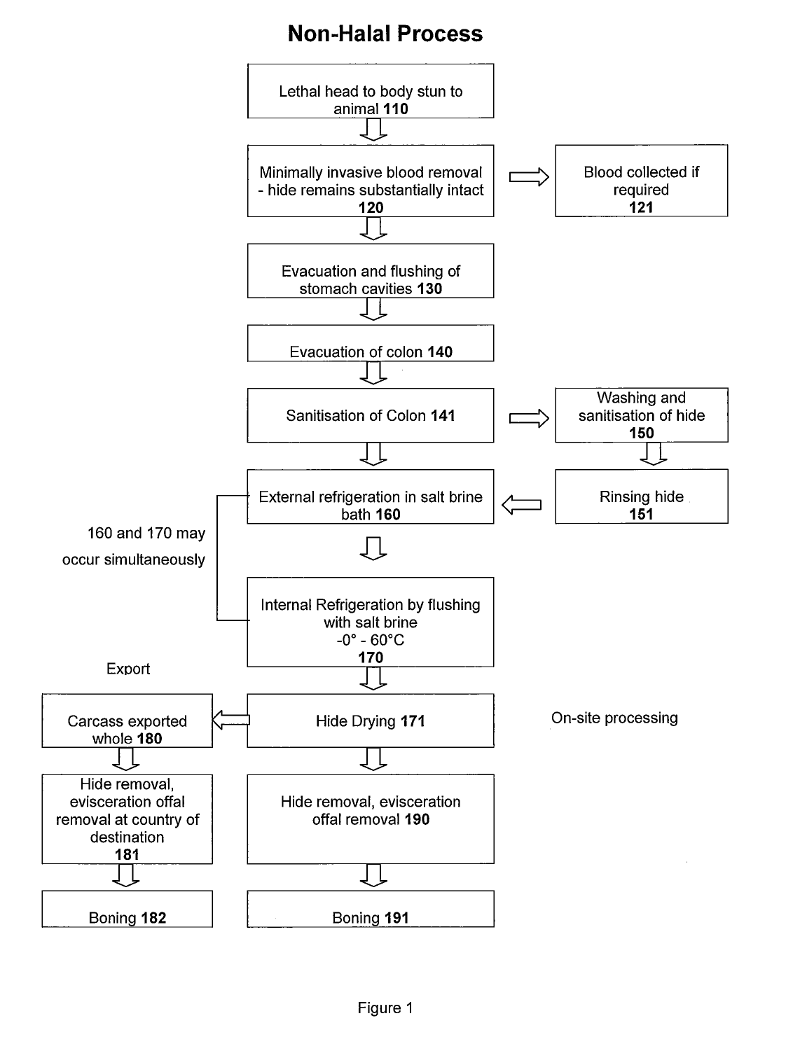

FIGS. 1 to 3 explain two methods of implementing the process in more detail.

The process is ideally suited to all ruminants (e.g. cattle, sheep, goats, deer) and monogastric animal species (e.g. pigs).

As would be understood by a person skilled in the art, the animals listed above are not intended to be a limiting list of animals that may be processed using the following methods.

FIG. 1 shows the process of the present invention in a preferred embodiment, that being a non-halal method of animal processing a ruminant animal, for example a sheep or a cow.

At 110 as shown in FIG. 1, the animal is subjected to a lethal head to body stun, using techniques readily available such as electrical head to body stunning. While a non-lethal stun may be used, the use of a lethal stun is preferable as it enables more effective minimally-invasive blood removal following the stun.

Following a lethal stun 110, the animal is then exsanguinated 120 using a sterilised 10 to 14-gauge hypodermic needle, inserted into the jugular vein. The blood may be collected 121 for later use (subject to the carcass being passed by the government approved meat inspector as fit for human consumption) if required or discarded.

The use of a hypodermic needle creates a very small puncture in the skin of the animal, particularly as the needle is hollow. Following removal of the needle, such small puncture wounds tend to substantially close up, providing minimal openings for bacteria or other micro-organisms. The blood of the animal has now been removed, with the hide substantially intact.

While this is the preferred method of exsanguination, other minimally invasive methods may be used, provided there is minimal damage to the hide of the animal, for example a traditional stick cut or use of a vampire knife inserted into the artery to drain blood away from the animal.

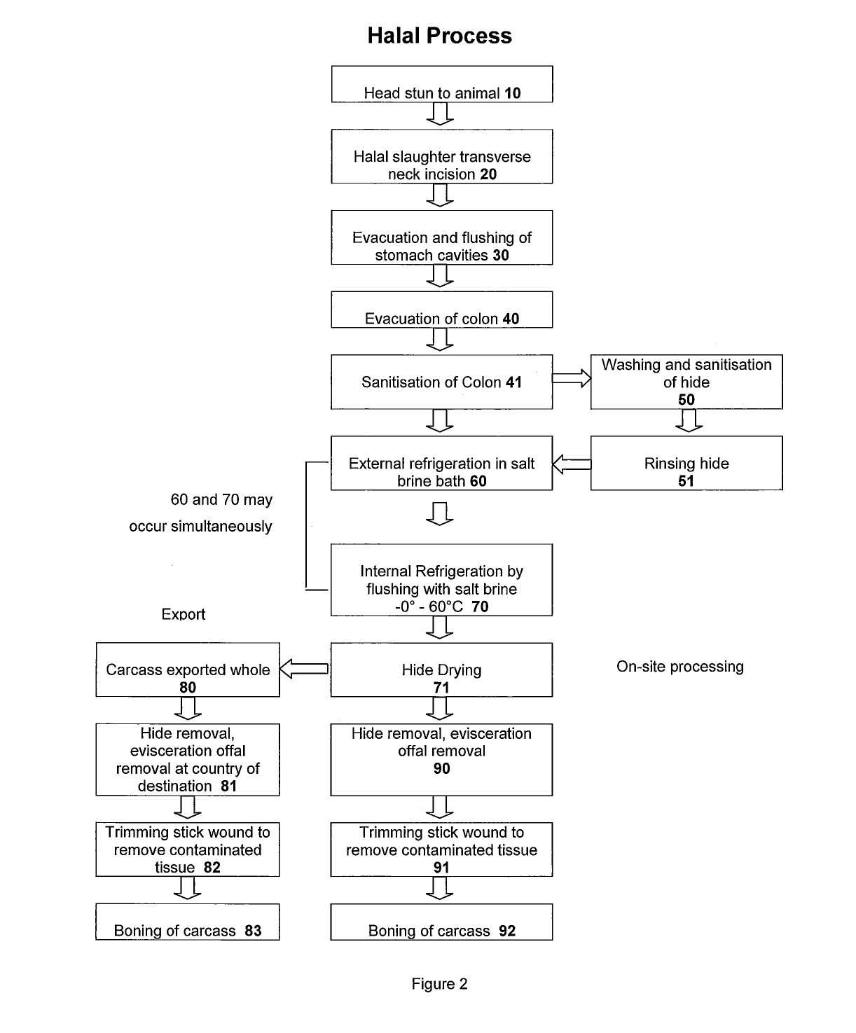

Methods for performing this process, including halal methods will be discussed further below with reference to FIG. 2.

In FIG. 1, following exsanguinations 120, the stomach cavity of the animal is evacuated 130 using a stomach tube and flushed with water until the water runs clear.

In other methods of preparation not outlined specifically in FIG. 1, flushing of the stomach may occur using a range of different fluids, either in liquid or gas form. For example, the stomach may be flushed with one or more of carbon dioxide, nitrogen or other inert gases to remove excess oxygen from the internal stomach, reducing the likelihood of metmyoglobin formation on intra-abdominal muscles.

In alternative methods a vacuum may be applied to the stomach to remove excess oxygen, or the stomach may be flushed with deoxygenated water. The above methods of deoxygenating the stomach region are not intended to be limiting and other techniques known in the art may be used for the same purpose.

The colon is then evacuated 140 and sanitised 141. Evacuation of the colon may be performed using known techniques. Preferably the colon is flushed using water until it runs clear. Sanitisation may then take place by flushing the colon with ozone or 200 ppm chlorine to remove and/or destroy any remaining bacteria. Other known disinfectants that are approved for use in meat processing may be used, as would be clear to a person skilled in the art.

As with the evacuation and flushing of the stomach region 130, evacuation and flushing of the colon region 140 may also be performed using a range of different fluids, either in liquid or gas form. The removal of excess oxygen within the colon may be achieved using the above mentioned gases or fluids.

Following flushing of the stomach cavity 130, an oxygen barrier is applied 135 to the inner stomach wall or walls to further prevent oxygen from contacting the carcass during processing and future refrigeration and storage. For carcasses intended to be stored over a period of weeks, minimal exposure to oxygen is essential for minimizing metmyoglobin formation in intra-abdominal muscles/organs and consequently maintaining acceptable meat quality.

Application of the oxygen barrier may be achieved using a variety of known techniques. One such technique includes the filling the stomach cavity with the oxygen barrier material, for example methyl cellulose, then subsequently draining the cavity to leave a residual layer coating the cavity walls.

The oxygen barrier may be selected from a range of different coatings available that are capable of forming a barrier between the environment and the carcass wall. Such coatings include but are not limited to coatings containing or being starch or derivatives thereof, methyl-cellulose, polysaccharide or protein based coatings or combinations thereof. Other food safe coatings that have barrier qualities may also be used, as would be clear to a person skilled in the art.

An oxygen barrier as described above may also be applied to the colon 142 following evacuation and sanitisation.

Following evacuation and sanitisation of the colon, the animal hide is then shorn (animals with a long fleece only, e.g. sheep) washed and sanitised 150 to remove external bacteria. The hide is cleansed thoroughly to remove all organic matter, followed by sanitisation to kill bacteria present on the hide. The effective sanitisation of the hide is beneficial for maintaining a low bacterial count on the finished product at the completion of the storage period.

Preferably, washing of the carcass takes place using an auto-immersion or auto-spray hide washing system using detergent and agitation, either mechanical or using water flow to dislodge dirt and other debris. Sanitation of the hide may be achieved by application of ozone or 200 ppm chlorine for example. This is preferably achieved by submersion of the carcass in one or more immersion tanks or spraying with a series of high pressure sprays. The washing and sanitising step 150 may be repeated as needed until the hide is clean and sanitised.

The carcass and hide is then rinsed 151 by immersion or spraying with water.

External refrigeration 160 of the carcass takes place once the carcass has been cleaned and sanitised externally and the stomach/rectum has been emptied/coated with an oxygen barrier. External refrigeration of the carcass takes place using one or more salt brine baths or series of brine sprays. The animal is transferred slowly through one or more chilled baths or sprays until a deep carcass temperature of −1.0 to −1.7° C. is achieved for carcasses being exported whole and 2° C.-6° C. for carcasses being boned on site.

The salt brine used in the present invention is preferably 20% CaCl and maintained at a temperature of approximately −24° C. At this temperature, a standard sized lamb can expect to reach a deep carcass temperature of −1.7° C. in approximately 4 hours. For carcass freezing, the animal is retained within the brine bath/spays until a deep carcass temperature is reached.

It is envisaged that a range of different brine baths/sprays at different temperatures may be used to minimise the cooling time of the carcass. Different sizes and types of animals may require different combinations of brine solutions, temperature and number and order of baths for optimum cooling.

The carcass may undergo internal refrigeration 170 either simultaneously with external refrigeration 160, or prior to or following external refrigeration 160. During internal refrigeration, the animal is flushed with a CaCl₂ salt brine solution of between 10° C. and −51° C.

The chilled brine solution is flushed into the stomach of the animal through the oesophagus and recirculated until the desired internal temperature is reached.

Once refrigerated to the desired temperature, the hide of the carcass may be dried 171. Typically the drying process will be used for carcasses being exported whole, as a means of weight reduction. This step becomes unnecessary when carcasses are being boned on site.

After drying of the hide 171, the carcass may be exported whole 180 in a chilled or frozen form. The carcass can then undergo skinning, evisceration, inspection by a government approved meat inspector and boning at the destination country by local workers as indicated by steps 181 and 182. Alternatively, the carcass may be further processed on site using known industry techniques for skinning, evisceration, inspection by a government approved meat inspector and boning as shown by steps 190 and 191. These techniques do not form part of the claimed invention and may be adapted as required for the final purpose of the product.

FIG. 2 outlines the process of the current invention when used to produce halal processed meat. Halal meat processing has a number of requirements, one of which is the requirement that the animal's throat be cut with a transverse incision. When halal processing is used with the present invention, the animal is not dealt a lethal stun at 10, but a head stun, and the throat slitting 20 is completed whilst the animal is still alive.

As can be seen in FIG. 2, with the exception of the transverse neck incision at 20, the process remains essentially the same as non-halal processing, with the addition of a trimming step 82 and 91 around the throat wound to remove contaminated tissue. This trimming and removal process ideally occurs following the sanitisation and refrigeration of the carcass and occurs after hide removal, evisceration and offal removal. Depending on the destination of the carcass in question, the trimming of the exposed area may be completed on site or at the export destination.

The steps of application of an oxygen barrier to the colon and/or stomach have not been used in the process outlined in FIG. 2. However, this should not be interpreted as an omission that the halal process should not include this step and it should be clear that this step may also be included in the halal process if required.

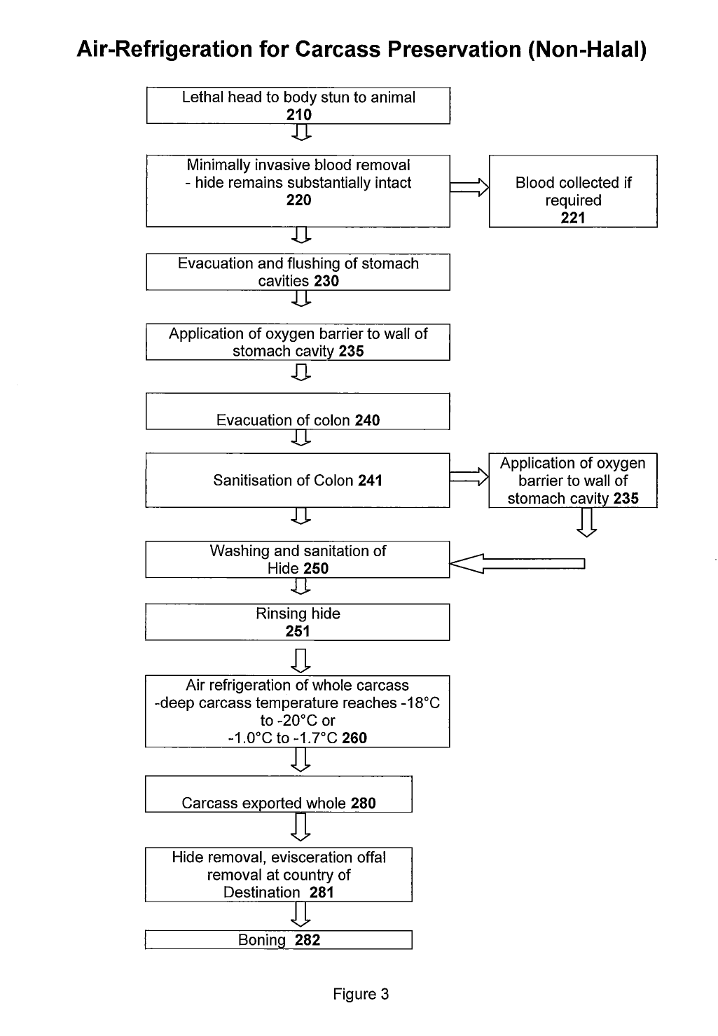

FIG. 3 shows the method of the present invention used for processing carcasses to be preserved at low temperature for export prior to evisceration and/or bone removal. The process of FIG. 3 process uses air refrigeration in place of the brine refrigeration as shown in FIGS. 1 and 2.

Steps 210-251 are identical to the corresponding steps in the process of FIG. 1. The animal hide remains intact following animal slaughter 210 and blood removal 220. Following blood removal 220, the stomach is evacuated and flushed 230, followed by the application of an oxygen barrier to the stomach walls 235. The colon is then also evacuated and flushed 240, then has an oxygen barrier applied to the colon wall 242.

As discussed with reference to the FIGS. 1 and 2 above, the stomach may be flushed with one or more fluids selected to either cleanse the stomach region and/or reduce the oxygen content remaining in the stomach. The oxygen barrier may be selected from a range of different coatings available that are capable of forming a barrier between the environment and the carcass wall. Such coatings include but are not limited to coatings containing or being starch or derivatives thereof, methyl-cellulose, polysaccharide or protein based coatings or combinations thereof.

Following colon sanitation, the hide is cleansed, sanitised 250 and rinsed 251 as outlined above in reference to the processes of FIGS. 1 and 2.

Following hide cleansing and sanitation, the carcass is then placed into an air refrigeration chamber 260, preferably a blast refrigerator or freezer until the deep carcass temperature has reached between −1.0 to −1.7° C. for carcasses to be stored for later processing or export in a refrigerated state, and of −12 to −20° C. for carcasses stored in a frozen state.

Following refrigeration or freezing, carcasses are stored and/or exported in a whole frozen or chilled state 280. When carcasses are ready to be processed, the carcass is thawed then hide is removed and evisceration and offal removal 281 occurs, followed by boning.

### Examples

### 1) Hide Removal/Evisceration Immediately after Hide Sanitation and Refrigeration

In initial process trials, a sheep carcass was processed according to steps 110-151 (halal process) of the invention. Following initial processing and washing/sanitation in 1,000 ppm chlorine as described above in steps 110-151, the animal carcass underwent internal and external refrigeration.

Specifically, the carcass was submerged for external refrigeration in a 20% NaCl brine solution at −15.5° C. The carcass simultaneously underwent internal refrigeration using a 20% NaCl bring solution at −15.5° C., with the brine being pumped into the animal stomach whilst in the external brine bath until the stomach was full. The internal brine was then left in the stomach during external refrigeration in the brine bath. At the time of entering the brine bath the deep temperature of the carcass was 32° C. and the surface temperature 20° C. External refrigeration continued in the −15.5° C. brine bath until the hind leg surface temperature was −1.5° C. then placed in a +2.6° C. bath and +2.6° C. internal brine applied continuously. The carcass was dressed when the surface temperature equilibrated to +2° C.

The bacterial sampling was collected as follows:

Sample A
Samples were collected immediately following hygienic dressing of each sampling location. These samples include samples collected from the halal cut neck wound prior to and after the exposed tissue being removed by trimming.

Sample B
Samples were collected from the hide before and after cleaning/sanitation of the hide, Carcass samples from the Y cut and flank sampling location after manually rubbing the outside of the hide onto the sampling area; A carcass sample from the hind leg sampling location after clearing the hind leg with a hand that had been rubbed on the outside of the hide.
Bacterial results are as follows:

Sample A

| | | | Aerobic Plate Count (Petrifilm) (MIMM 6) | |
|---|---|---|---|---|
| | | | Aerobic Plate Count | Aerobic Plate Count (Log) |
| Sample Identification | | | CFU/cm² | Log10 CFU/cm² |
| 3445699 | 6/1a - 1 | Y Cut - L 15:00 | 0.3 | −0.52 |
| 3445700 | 6/1a - 2 | Flap - L 15:15 | 0.3 | −0.52 |
| 3445701 | 6/1a - 3 | H. Leg - L 15:30 | 0.3 | −0.52 |
| 3445702 | 6/1a - 4 | Neck Wound 14:45 | 35 | 1.54 |
| 3445703 | 6/1a - 6 | Trimmed Neck 14:50 | 1 | 0 |

| | | | E. coli Count (Petrifilm) (MIMM 8.4) | |
|---|---|---|---|---|
| | | | E. coli Count | E. coli Count (Log) |
| Sample Identification | | | CFU/cm² | Log10 CFU/cm² |
| 3445699 | 6/1a - 1 | Y Cut - L 15:00 | Not Detected | −0.53 |
| 3445700 | 6/1a - 2 | Flap - L 15:15 | Not Detected | −0.53 |
| 3445701 | 6/1a - 3 | H. Leg - L 15:30 | Not Detected | −0.53 |
| 3445702 | 6/1a - 4 | NeckWound 14:45 | Not Detected | −0.31 |
| 3445703 | 6/1a - 6 | Trimmed Neck 14:50 | Not Detected | −0.31 |

Sample Integrity

| | |
|---|---|
| Temperature on Arrival | 1.2° C. |
| Samples Received Intact | Yes |

Report Results Information

| | |
|---|---|
| Sampler(s) | J. Riley |
| Date/Time Sampled | 12/08/13 14:45 |
| Date/Time Received | 13/08/13 08:00 |
| Date/Time Tested | 13/08/13 11:30 |

| Sample B | |
|---|---|
| | Aerobic Plate Count (Petrifilm) (MIMM 6) |

| | | | Aerobic Plate Count | Aerobic Plate Count (Log) |
|---|---|---|---|---|
| Sample Identification | | | CFU/cm² | Log10 CFU/cm² |
| 3445706 | 6/1b-2 | Flank Pre wash pelt swab | 4740 | 3.68 |
| 3445708 | 6/1b-4 | Flank Post wash pelt swab | 16.8 | 1.23 |
| 3445709 | 6/1b-5 | Y Cut - R | 8.4 | 0.92 |
| 3445710 | 6/1b-6 | Flap - R | 2.7 | 0.43 |
| 3445711 | 6/1b-7 | H. Leg - R | 0.6 | −0.22 |

E. coli Count (Petrifilm) (MIMM 8.4)

| | | | E. coli Count | E. coli Count (Log) |
|---|---|---|---|---|
| Sample Identification | | | CFU/cm² | Log10 CFU/cm² |
| 3445706 | 6/1b-2 | Flank Pre wash pelt swab | 20.4 | 1.31 |
| 3445708 | 6/1b-4 | Flank Post wash pell swab | Not Detected | −0.53 |
| 3445709 | 6/1b-5 | Y Cut - R | Not Detected | −0.53 |
| 3445710 | 6/1b-6 | Flap - R | Not Detected | −0.53 |
| 3445711 | 6/1b-7 | H. Leg - R | Not Detected | −0.53 |

Sample Integrity

| | |
|---|---|
| Temperature on Arrival | 1.2° C. |
| Samples Received Intact | Yes |

Report Results Information

| | |
|---|---|
| Sampler(s) | J. Riley |
| Date/Time Sampled | 12/08/13 12:30 |
| Date/Time Received | 13/08/13 08:30 |
| Date/Time Tested | 13/08/13 11:30 |

2) Hide Removal/Evisceration Following Chilled Preservation

In initial process trials, a sheep carcass was processed according to steps 110-151 (non-halal process) of the invention. Following initial processing and washing as described above in steps 110-151, the animal carcass underwent internal and external refrigeration.

Specifically, the carcass was submerged for external refrigeration in a 15% CaCl₂+10% NaCl brine solution at −20° C. The carcass simultaneously underwent internal refrigeration using a 15% CaCl₂+10% NaCl bring solution at −25° C., with the brine being pumped into the animal stomach whilst in the external brine bath.

At the time of entering the brine bath, the carcass surface temperature was 22° C. and the deep temperature of the carcass was 30° C. at the commencement of refrigeration.

During refrigeration, the surface temperature was reduced to −4° C. in 4 hours, at which time the deep leg temperature was measured to be 1.5° C.

The intact carcass was then refrigerated for 6 weeks in a chiller at 1.5° C.

After six weeks the skin was removed and sampling conducted on the surface of the meat, samples were also taken from internal organs after the abdomen was opened. The bacterial sampling results are as follows:

| | | Customer Sample ID | | |
|---|---|---|---|---|
| | | 1 Outside Foreshank | 2 Shoulder | 3 Flank |
| | | Eurofins Sample No. | | |
| Test/Reference | Unit | 3293631 | 3293632 | 3293633 |
| Aerobic Plate Count (Petrifilm) MIMM 6 | | | | |
| Aerobic Plate Count | CFU/cm² | Not Detected | Not Detected | Not Detected |
| Aerobic Plate Count (Log) | Log10 CFU/cm² | −0.31 | −0.31 | −0.31 |

| | | Customer Sample ID | | |
|---|---|---|---|---|
| | | 4 Flank Green | 5 Back Strap | 6 Top Hind Leg |
| | | Eurofins Sample No. | | |
| Test/Reference | Unit | 3293634 | 3293635 | 3293636 |
| Aerobic Plate Count (Petrifilm) MIMM 6 | | | | |
| Aerobic Plate Count | CFU/cm² | 2 | Not Detected | Not Detected |
| Aerobic Plate Count (Log) | Log10 CFU/cm² | 0.30 | −0.31 | −0.31 |
| Escherichia coli Count MIMM 8.4 | | | | |
| Escherichia coli Count | CFU/cm² | Not Detected | — | — |
| Escherichia coli Count (Log) | Log10 CFU/cm² | −0.31 | — | — |
| | | Customer Sample ID | | |
| | | 7 Mid Hind Leg | 8 Colon | 9 Greater Omentum |
| | | Eurofins Sample No. | | |
| Test/Reference | Unit | 3293637 | 3293638 | 3293639 |
| Aerobic Plate Count (Petrifilm) MIMM 6 | | | | |
| Aerobic Plate Count | CFU/cm² | Not Detected | Not Detected | Not Detected |
| Aerobic Plate Count (Log) | Log10 CFU/cm² | −0.31 | −0.31 | −0.31 |
| Escherichia coli Count MIMM 8.4 | | | | |
| Escherichia coli Count | CFU/cm² | — | Not Detected | Not Detected |
| Escherichia coli Count (Log) | Log10 CFU/cm² | — | −0.31 | −0.31 |

| | | Customer Sample ID | | |
|---|---|---|---|---|
| | | 10 Jejunym | 11 Liver | 12 Rumen |
| | | Eurofins Sample No. | | |
| Test/Reference | Unit | 3293640 | 3293641 | 3293642 |
| Aerobic Plate Count (Petrifilm) MIMM 6 | | | | |
| Aerobic Plate Count | CFU/cm² | Not Detected | 4 | 2 |
| Aerobic Plate Count (Log) | Log10 CFU/cm² | −0.31 | 0.60 | 0.30 |
| Escherichia coli Count MIMM 8.4 | | | | |
| Escherichia coli Count | CFU/cm² | Not Detected | Not Detected | Not Detected |
| Escherichia coli Count (Log) | Log10 CFU/cm² | −0.31 | −0.31 | −0.31 |

| | | Customer Sample ID | | |
|---|---|---|---|---|
| | | 13 Inside Flap | 14 Heart | 15 Kidney |
| | | Eurofins Sample No. | | |
| Test/Reference | Unit | 3293643 | 3293644 | 3293645 |
| Aerobic Plate Count (Petrifilm) MIMM 6 | | | | |
| Aerobic Plate Count | CFU/cm² | 2 | Not Detected | Not Detected |
| Aerobic Plate Count (Log) | Log10 CFU/cm² | 0.30 | −0.31 | −0.31 |
| Escherichia coli Count MIMM 8.4 | | | | |
| Escherichia coli Count | CFU/cm² | Not Detected | — | Not Detected |
| Escherichia coli Count (Log) | Log10 CFU/cm² | −0.31 | — | −0.31 |

| | | Customer Sample ID | |
|---|---|---|---|
| | | 16 Inside Pelvis | 17 Inside Hind Leg |
| | | Eurofins Sample No. | |
| Test/Reference | Unit | 3293646 | 3293647 |
| Aerobic Plate Count (Petrifilm) MIMM 6 | | | |
| Aerobic Plate Count | CFU/cm² | 24 | 34 |
| Aerobic Plate Count (Log) | Log10 CFU/cm² | 1.38 | 1.53 |
| Escherichia coli Count MIMM 8.4 | | | |
| Escherichia coli Count | CFU/cm² | Not Detected | Not Detected |
| Escherichia coli Count (Log) | Log10 CFU/cm² | −0.31 | −0.31 |

Sample Integrity

| | |
|---|---|
| Temperature on Arrival | 1.3° C. |
| Samples Received Intact | Yes |

Report Results Information

| | |
|---|---|
| Sampler(s) | D. Riley |
| Date/Time Sampled | 03/03/13 13:00 |
| Date/Time Received | 04/03/13 11:15 |
| Date/Time Tested | 04/03/13 13:00 |
| Sample Type | Swabs ex 5 cm² |

3) Hide Removal/Evisceration Following Frozen Preservation

In initial process trials, a sheep carcass was processed according to steps 110-151 (halal process) of the invention.

During initial processing the stomach was emptied then filled with starch/methyl cellulose, the carcass was inverted to remove all water/excess starch/methyl cellulose then filled with CO₂ gas and oesophagus clipped. The rectum was also filled with starch/methyl cellulose.

Following initial processing and washing as described above in steps 110-151, the animal carcass underwent external refrigeration (ie—no internal refrigeration).

Specifically, the carcass was submerged for external refrigeration in a 20% NaCl brine solution at −5° C. Note that the brine refrigeration system was faulty during the trial and consequently the carcass had to be transferred to an air freezer after initial refrigeration in the brine freezer.

During refrigeration, the deep carcass (data logger probe inserted in the center of the lambs brain via the hole in the skull created by the captive bolt) was reduced to and then maintained at −18.5° C.

After eight weeks the skin was removed and sampling conducted on the surface of the meat, samples were also taken from internal organs after the abdomen was opened.

Earlier trials with carcasses preserved by freezing resulted in meat quality issues due to metmyoglobin formation on the tenderloin. This was resolved in this trial by the application of starch/methyl cellulose to the stomach and filling the stomach with CO₂ gas. The same effect may be achieved by only partially emptying the stomach contents (e.g.—using a suction device) and applying a gas barrier (i.e. a O₂& CH₄ gas barrier) surface coating to the stomach prior to preservation of the carcass.

Following freezing the carcass was placed in a water bath at a temperature of 38° C. to thaw for 5 hours then processed. The hide subcutaneous tissue of the carcass regains its elasticity after thawing to approx 1° C. and ease of hide removal is subsequently similar to hide removal of a hot carcass. The viscera of the carcass was still partially frozen at the time the carcass was processed, but this had no negative impact on the ease of dressing.

All organoleptic qualities (appearance, tenderness and taste after cooking) of all products from the abdominal (e.g.—meat, offal, tripe and green runners), thoracic (e.g.—heat/lungs) and subcutaneous (e.g.—meat from muscles under the hide) parts of the carcass were perfect following thawing. Note that there was a small amount of yellow staining present on the omental and kidney fat within the abdomen, however bacterial sampling confirmed this is not due to bacterial contamination of these tissues.

The bacterial sampling results are as follows:

| | | | Aerobic Plate Count (Petrifilm) (MIMM 6) | |
|---|---|---|---|---|
| | | | Aerobic Plate Count | Aerobic Plate Count (Log) |
| Sample Identification | | | CFU/cm² | Log10 CFU/cm² |
| 3596913 | 8/5 A | Untrimmed Neck | 22 | 1.34 |
| 3596914 | 8/5 E | Trimmed Neck | 4 | 0.60 |
| 3596915 | 8/5 C | Y Cut | Not Detected | −0.31 |
| 3596916 | 8/5 D | Outside Flap | Not Detected | −0.31 |
| 3596917 | 8/5 E | Hind Leg | Not Detected | −0.31 |
| 3596918 | 8/5 F | Inside Flap | Not Detected | −0.31 |
| 3596919 | 8/5 G | Stain (Omental Fat) | Not Detected | −0.31 |
| 3596920 | 8/5 H | S I (Stained) | Not Detected | −0.31 |
| 3596921 | 8/5 I | L I | Not Detected | −0.31 |
| 3596922 | 8/5 J | Paunch | Not Detected | −0.31 |
| 3596937 | 8/5 K | Stain (Outer Kidney Fat) | Not Detected | −0.31 |

| | | | Escherichia coli Count (MIMM B.4) | |
|---|---|---|---|---|
| | | | Escherichia coli Count | Escherichia coli Count (Log) |
| Sample Identification | | | CFU/cm² | Log10 CFU/cm² |
| 3596913 | 8/5 A | Untrimmed Neck | Not Detected | −0.31 |
| 3596914 | 8/5 B | Trimmed Neck | Not Detected | −0.31 |
| 3596915 | 8/5 C | Y Cut | Not Detected | −0.31 |
| 3596916 | 8/5 D | Outside Flap | Not Detected | −0.31 |
| 3596917 | 8/5 E | Hind Leg | Not Detected | −0.31 |
| 3596918 | 8/5 F | Inside Flap | Not Detected | −0.31 |
| 3596919 | 8/5 G | Stain (Omental Fat) | Not Detected | −0.31 |
| 3596920 | 8/5 H | S I (Stained) | Not Detected | −0.31 |
| 3596921 | 8/5 I | L I | Not Detected | −0.31 |
| 3596922 | 8/5 J | Paunch | Not Detected | −0.31 |
| 3596937 | 8/5 K | Stain (Outer Kidney Fat) | Not Detected | −0.31 |

Sample Integrity

| | |
|---|---|
| Temperature on Arrival | 6.4° C. |
| Samples Received Intact | Yes |

Report Results Information

| | |
|---|---|
| Sampler(s) | J. Riley |
| Date/Time Sampled | 02/01/14 17:00 |
| Date/Time Received | 03/01/14 14:00 |
| Date/Time Tested | 03/01/14 15:30 |
| Sample Type | Swabs - Meat ex 5 cm² |

The above aerobic plate counts (APC) on each of the methods used show a very low, or undetectable APC level, indicating the process of the present invention is very effectively providing a hygienic and safe method of carcass processing.

As a comparison, the results of the bacterial analysis can be compared to the requirements given by the New Zealand Ministry for Primary Industries.

For example, the Y cut APC limit for sheep processing in NZ for carcasses prior to grading on the slaughter floor is not more than 2 results in the last 15 results above 44,668 cfu/cm².

Using the process of the present invention, Y cut Aerobic plate count levels from samples in experimental methods 1A, 1B and 3 were Nil, 8.4 cfu/cm² and nil respectively. These levels are a major improvement on the acceptable levels currently provided by the government.

The average of 69,658 Y cut APC results for sheep carcasses as reported in the Ministry for Primary Industries National Microbiological Database to the end of the third quarter 2013 for carcasses prior to grading on the slaughter floor is 794 cfu/cm². Results using the current process are significantly lower than this, providing a much improved processing method over the current known processing techniques.

Method 3 of the present invention as shown above included an eight week storage term following processing using the present invention, followed by freezing.

After 8 weeks the carcasses where thawed, skinned and eviscerated. Once thawed, nine out of 11 sites tested showed a nil APC, with two sites showing levels of 22 and 4 cfu/cm². E. coli levels across all sites were nil (undetected).

These results show an exceptional improvement over current techniques. For example, the current APC limit set by Tesco in Britain for chilled vacuum packed cuts 49 days after packing is 100,000 cfu/cm². Many NZ meat processors struggle to comply with this limit using current techniques. The implementation of the current processing methods outlined herein provides a significant advantage over known techniques in processing and storing of carcasses over a significant period of time.

Further advantages of the invention over known methods are outlined below.

By retaining the hide on the animal, the hide acts as a natural barrier to bacteria. The hide is able to be washed and sanitized before the carcass is cut and boned, drastically reducing cross contamination. Transfer of bacteria from an unwashed animal carcass onto the animal's meat is a major cause of meat contamination. In current practice, the animal is skinned before refrigeration, allowing the growth of pathogens to continue until carcass temperature is reduced to below 7° C. several hours later and growth of spoilage microorganisms to continue until product has been reduced to −1.5° C.

Using the method of the current invention, the majority of the bacteria is removed and the carcass is refrigerated both internally and externally before any skin removal takes place.

The majority of pathogens of concern in meat processing are mesophiles, growing at body temperature and as low as 7° C. By sanitizing the animal internally and externally and reducing the temperature of the carcass to below 7° C. before any skin removal occurs, the levels of pathogen detected on the meat is likely to be minimal.

Testing of pathogens is extremely stringent, particularly when meat is being exported to countries such as the USA. Carcasses are tested for E. coli H7:O157 and the other top six Shiga Toxigenic E. coli (STEC) organisms to determine eligibility for the USA market.

The reduction in such bacteria is one of the major advantages of this process and results in both a product with a superior shelf life due to the minimal spoilage bacterial loading, improved food safety due to reduced contamination of the meat with pathogens and an increase in successful exports due to the reduced rate of E. coli H7:O157/Super 6 STEC detections. In particular, the applicant believes the process will result in minimal contamination of meat with pathogenic bacteria such as E. coli H7:O157 or the “super 6” E. coli or Salmonella. The resulting meat is less lightly to be downgraded due to testing positive for E. coli H7:O157 or the “super 6” STEC's. Currently, a large quantity of export bobby veal is downgraded due to E. coli H7:O157/Super 6 STEC's contamination.

The refrigeration time/energy cost using the present invention is significantly less than that in current processing practices. The use of refrigeration with a brine solution reduces refrigeration time by over 200% (estimate 3 hours to reduce deep carcass temperature to <7° C. compared with currently approx. 12 hours, when compared to conventional air chilling techniques). Savings in time also result in cost efficiencies in the overall process.

The current process has as further advantage in that workers only need to wash their hands and sterilize their knives between carcasses because of the sanitary state of the hide (subject to approval by regulatory authorities). Using conventional processing techniques, workers must wash their hands and sterilize the knife multiple times for the same carcass.

A further advantage of the current process is that it is likely there will be no weight loss of the carcass that would normally happen when carcasses are refrigerated in an air chiller. This ultimately results in the best price for the carcass by weight.

For non-halal processing, the method of blood removal allows for collection of edible blood with minimal bacterial contamination. This provides a further potential revenue stream.

One major advantage as mentioned earlier is the ability of the carcass to be exported whole following refrigeration or freezing. Once in the destination country the remaining processing can be performed with potentially cheaper labor, which reduces overall processing costs. Hygiene standards may also differ from country to country and the low bacterial growth found on chilled carcasses processed using this method should meet standards in a wide range of countries. This export of whole refrigerated carcasses produced using this method provides a useful alternative between export of live animals, and fully processed meat. The method has all the advantages of live animal export, but without the logistical issues of feeding animals during shipment and difficulties with animal welfare, both during transport and on arrival.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A method of processing a plurality of animal carcasses in an industrial processing plant, the method comprising the steps of:
removing substantially all the blood from the plurality of animal carcasses, then freezing at least a part of the animal carcasses prior to hide removal and evisceration.

2. (canceled)

3. The method of processing an animal as claimed in claim 1, wherein the carcasses are at least partly frozen using internal and/or external application of a low temperature fluid of between 0° C. and −51° C.

4. (canceled)

5. The method as claimed in claim 1, wherein, the animal hides remain substantially intact following blood removal.

6. (canceled)

7. The method for processing animal carcasses as claimed in claim 1, the method further comprising the steps of:
a) stunning an animal;
b) removing blood from the animal carcass;
c) evacuating the stomach; and
d) freezing at least part of the animal carcass
wherein the hide remains substantially intact on the animal or animal carcass throughout steps a) to d).

8. The method of processing animal carcasses as claimed in claim 1, for each animal/animal carcass the method further comprising the steps of:
a) removing blood from the animal carcass;
b) evacuating the stomach;
c) evacuating the colon;
d) flushing colon with disinfectant solution;
e) washing and sanitization of carcass hide;
f) rinsing carcass; and
g) freezing at least part of the animal carcass
wherein the hide remains substantially intact on the animal or animal carcass throughout steps a) to g).

9. The method for processing animal carcasses as claimed in claim 8, the method further comprising one or more of the steps of;
a) stunning the animals prior to blood removal;
b) following freezing, removal of the animal hide;
c) following freezing, evisceration and/or offal removal; and
d) following freezing, boning of the carcasses.

10. (canceled)

11. (canceled)

12. (canceled)

13. The method as claimed in claim 1, the method including the step of evacuating and flushing the stomach and/or colon with fluid through the oesophagus.

14. (canceled)

15. The method of claim 13, wherein the stomach and/or colon is fully or partially evacuated using a suction mechanism.

16. (canceled)

17. (canceled)

18. (canceled)

19. (canceled)

20. (canceled)

21. The method as claimed in claim 1, wherein the carcasses are externally and/or internally at least partly frozen using a low temperature liquid solution.

22. (canceled)

23. The method as claimed in claim 21, wherein the freezing step comprises submerging or partially submerging the carcass in a low temperature liquid, bath or series of low temperature liquid baths; and/or internal freezing by internal flushing with a low temperature liquid solution.

24. The method as claimed in claim 23 wherein the freezing step comprises applying a low temperature liquid spray or series of low temperature liquid sprays to the animal carcass.

25. The method as claimed in claim 23, wherein the carcasses are at least partly frozen using a low temperature liquid of between 0° C. and −51° C.

26. (canceled)

27. The method as claimed in claim 21, wherein the carcasses are submerged in one or more low temperature liquid baths until the deep carcass temperature is reduced to between 7° C. and −20° C.

28. The method as claimed in claim 21, wherein the carcasses are at least partly frozen with a low temperature liquid spray until the deep carcass temperature is reduced to between 7° C. and −20° C.

29. (canceled)

30. (canceled)

31. The method of claim 23, wherein following external and internal freezing using low temperature liquid solution, the carcasses are dried in an air chiller at −1.7° C.

32. The method as claimed in claim 1, wherein the carcasses are at least partly frozen using air freezing methods.

33. (canceled)

34. (canceled)

35. (canceled)

36. The method of claim 1, further comprising the step of thawing the animal carcass.

37. A method of thawing the frozen animal carcass processed according to claim 1 wherein the method further comprises:
receiving the frozen animal carcass, and
thawing the frozen animal carcass by applying heat to the frozen animal carcass.

38. (canceled)

39. (canceled)

40. (canceled)

41. An animal carcass processed using the method claimed in claim 1.
